(19) United States
(12) Patent Application Publication
(10) Pub. No.: US 2016/0100224 A1
(43) Pub. Date: Apr. 7, 2016

(54) Client Driven Video Presentation for Public Venues

(71) Applicant: Terressa L. Nordstrom, Azle, TX (US)

(72) Inventor: Terressa L. Nordstrom, Azle, TX (US)

(21) Appl. No.: 14/507,022

(22) Filed: Oct. 6, 2014

(51) Int. Cl. H04N 21/472; H04N 21/234; H04N 21/61; H04N 21/81

(52) U.S. Cl. CPC H04N 21/47202; H04N 21/812; H04N 21/23424; H04N 21/6175; H04N 21/6125

(57) ABSTRACT

Selective delivery of video channel content to audiences of users at plural venues through the Internet. A channel server receives video channel content including URL of streaming video server files, banner text, and server messages, which are organized by discrete video channel identities. Portions are served to plural discrete video channels. Venue controllers receive video channel content from the channel server, and, sequentially displays banner text, server messages, and streaming videos. Client terminals search for video content and select videos for playback at their local venues.

### BACKGROUND OF THE INVENTION

1. Field of the Invention

The present invention relates to video entertainment in public venues. More specifically, the present invention relates to use of a network server system for presentation of video entertainment at a public venue, with video content selected by individuals in attendance, and including advertising content.

2. Description of the Related Art

There are a wide variety of public venues where entertainment is provided to individuals in attendance. Examples of such venues are bars, taverns, social clubs, pubs, nightclubs, dance halls, concerts, houses of worship, schools, colleges, government organizations, and the like. Forms of entertainment can be subdivided into aural and visual, as well as live and recorded. Music is commonly played through a venue sound system for the enjoyment of individuals in attendance. Similarly television sets may be provided such that individuals can view and hear television programming, sports, and other video content. Certain venues may style the entertainment to a certain audience, for example country and western music in a dance hall. This approach caters to the entertainment desires of the audience.

A common source of entertainment is the jukebox, where individuals in attendance can select a song for reproduction, generally subject to a small fee. This approach enables individuals to pick their entertainment content rather than relying on the proprietors of the venue to make the decision for them. Jukeboxes operate for a profit generally, with compensation provided through various means. With the ubiquity of the Internet as well as the ubiquity of the Smartphone and other wireless computing devices, and considering the general prevalence of aural entertainment as opposed to video entertainment, it can be appreciated that there is a need in the art of the system and method that can selectively deliver video entertainment in venues as discussed, as well as leveraging the ubiquitous presence of the wireless service, Internet access and web services.

### SUMMARY OF THE INVENTION

The need in the art is addressed by the systems and methods of the present invention. The present disclosure teaches a system for selective delivery of video channel content to audiences of users at plural venues. The system includes an Internet coupled channel server that receives video channel content consisting of uniform resource identifiers for streaming video server files, banner text, and server messages, which are organized by discrete video channel identities, and which serves portions of the video channel content, correspondingly, to plural discrete video channels. A first venue controller is coupled to receive first video channel content, identified by a first discrete video channel identity, from the channel server, and, the first venue controller sequentially displays banner text portions and server message portions of the first video channel content on a video display at a corresponding first venue, and further requests streaming video feeds from Internet video servers according to video server uniform resource identifier portions of the first video channel content, which are also sequentially displayed on the video display. A first client terminal, also coupled through the Internet, provides an interface for a user search for video server uniform resource identifiers available on Internet video servers, and then communicates user selected video server uniform resource identifiers, identified by the first discrete channel identity, to the channel server. In operations, the channel server receives the selected video server uniform resource identifiers from the first client terminal, and inserts the selected video server uniform resource identifiers into a queue for inclusion into the first video channel content that is served to the first venue controller.

In a specific embodiment of the foregoing system, the banner text portions of the video channel content are advertisement messages served only to the first venue controller according to the discrete channel identity. In another specific embodiment, the server message portions of the video channel content are advertisement messages served to plural venue controllers according to plural discrete channel identities. In another specific embodiment, the channel server inserts a uniform resource identifier of a streaming video file into the queue of the first venue controller that is an advertisement video, thereby interspersing video advertisements into the served video channel content.

In a specific embodiment of the foregoing system, the channel server serves the video channel content immediately after the first venue controller sends acknowledgement that a prior item of video channel content display operation has been completed.

In a specific embodiment of the foregoing system, the channel server serves the video channel content, for each of the banner text, the server messages, and the uniform resource identifiers for streaming video server files, correspondingly, through a banner text queue, a system message queue, and a uniform resource identifiers for streaming video server files queue. In a refinement to this embodiment, the banner text queue and the system message queue include a start time and duration time for display of each item therein.

In a specific embodiment of the foregoing system, the first client terminal provides a command with one of the selected video server uniform resource identifiers, and the channel server advances the selected video server uniform resource identifiers to the top of the queue in response to receipt of the command. In another specific embodiment, the first venue controller allocates separate portions of the video display for reproduction of the banner text portion, the server message portions, and the streaming video feeds. In another specific embodiment, the server messages include graphical files that are uploaded to the channel server by a third party advertiser.

The present disclosure also teaches a method for selectively delivering video channel content through the Internet to audiences of users at plural venues using a channel server, at least a first venue controller coupled to a video display, and at least a first client terminal. The method includes the steps of receiving video channel content, by the channel server, consisting of uniform resource identifiers for streaming video server files, banner text, and server messages, organized by discrete video channel identities, and serving portions of the video channel content, correspondingly, to plural discrete video channels. It further includes receiving first video channel content from the channel server, by the first venue controller, identified by a first discrete video channel identity, and sequentially displaying banner text portions and server message portions of the first video channel content on the video display at a corresponding first venue, and requesting streaming video feeds from Internet video servers, by the first venue controller, according to video server uniform resource identifier portions of the first video channel content, and, sequentially displaying the streaming video feeds on the video display. The method further includes searching for video server uniform resource identifiers available on Internet video servers by the first client terminal, and communicating selected video server uniform resource identifiers, identified by the first discrete channel identity, to the channel server, and, receiving, by the channel server, the selected video server uniform resource identifiers from the first client terminal, and inserting the selected video server uniform resource identifiers into a queue for inclusion into the first video channel content, and serving it to the a first venue controller.

In a specific embodiment, the forgoing method further includes inserting advertising messages into the banner text portions of the video channel content, and serving them only to the first venue controller according to the discrete channel identity. In another specific embodiment, the method further includes inserting advertisement content into the server message portions of the video channel content, and serving them to plural venue controllers according to plural discrete channel identities.

In a specific embodiment, the forgoing method further includes inserting, by the channel server a uniform resource identifier of a streaming video file into the queue of the first venue controller that is an advertisement video, thereby interspersing video advertisements into the served video channel content.

In a specific embodiment, the forgoing method further includes displaying an item of video channel content by the first venue controller, sending an acknowledgement, by the first venue controller, that the item of video channel content displaying operation is complete, and serving another item of video channel content, by the channel server, upon receipt of the acknowledgement.

In a specific embodiment, the forgoing method further includes serving the video channel content, by the channel controller, for each of the banner text, the server messages, and the uniform resource identifiers for streaming video server files, correspondingly, through a banner text queue, a system message queue, and a uniform resource identifiers for streaming video server files queue. In a refinement to this embodiment, the banner text queue and the system message queue include a start time and duration time for displaying of each item therein.

In a specific embodiment, the forgoing method further includes sending a command, by the first client terminal, together with one of the selected video server uniform resource identifiers, wherein the channel server advances the one of the selected video server uniform resource identifiers to the top of the queue in response to receipt of the command.

In a specific embodiment, the forgoing method further includes allocating separate portions of the video display, by the first venue controller, and reproducing the banner text portion, the server message portions, and the streaming video feeds in the separate portions of the video display. In another specific embodiment, the foregoing method further includes uploading graphical files within the server messages to the channel server by a third party advertiser.

### BRIEF DESCRIPTION OF THE DRAWINGS

FIG. 1 is a drawing of a venue implementation according to an illustrative embodiment of the present invention.

FIG. 2 is a system level functional block diagram according to an illustrative embodiment of the present invention.

FIG. 3 is an information flow diagram according to an illustrative embodiment of the present invention.

FIG. 4 is a drawing of a venue video display screen according to an illustrative embodiment of the present invention.

FIG. 5 is a drawing of a venue controller screen according to an illustrative embodiment of the present invention.

FIG. 6 is a drawing of a generic client terminal display according to an illustrative embodiment of the present invention.

FIG. 7 is a drawing of a mobile client terminal display according to an illustrative embodiment of the present invention.

FIG. 8 is a drawing of a mobile client terminal display according to an illustrative embodiment of the present invention.

FIG. 9 is a drawing of a mobile client terminal display according to an illustrative embodiment of the present invention.

FIG. 10 is a user access sequence flow diagram according to an illustrative embodiment of the present invention.

FIG. 11 is a venue access flow diagram according to an illustrative embodiment of the present invention.

FIG. 12 is a channel operation flow diagram according to an illustrative embodiment of the present invention.

### DESCRIPTION OF THE INVENTION

Illustrative embodiments and exemplary applications will now be described with reference to the accompanying drawings to disclose the advantageous teachings of the present invention.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope hereof and additional fields in which the present invention would be of significant utility.

In considering the detailed embodiments of the present invention, it will be observed that the present invention resides primarily in combinations of steps to accomplish various methods or components to form various apparatus and systems. Accordingly, the apparatus and system components, and method steps have been represented where appropriate by conventional symbols in the drawings, showing only those specific details that are pertinent to understanding the present invention so as not to obscure the disclosure with details that will be readily apparent to those of ordinary skill in the art having the benefit of the disclosures contained herein.

In this disclosure, relational terms such as first and second, top and bottom, upper and lower, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises a” does not, without more constraints, preclude the existence of additional identical elements in the process, method, article, or apparatus that comprises the element.

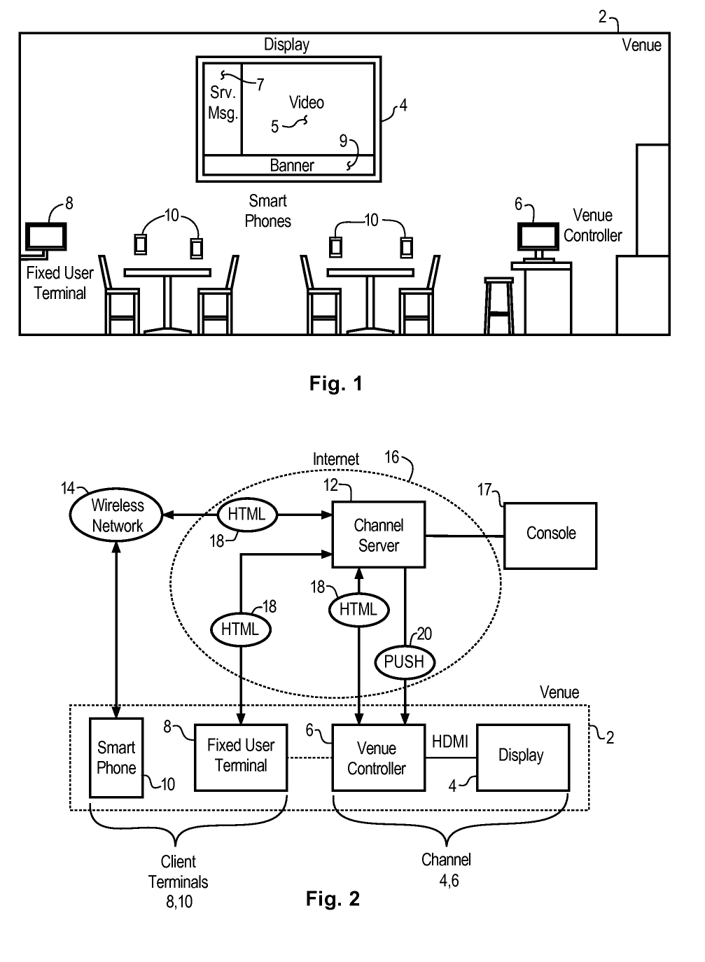

Reference is directed to FIG. 1, which is a drawing of a venue 2 implementation according to an illustrative embodiment of the present invention. A venue 2, which is a nightclub in this example, hosts plural individuals as guests (not shown) who are users and clients of the systems and methods of the present invention. A video display 4 is coupled to a venue controller 6, which drives the content of the video display 4. In this embodiment, the venue controller 6 is a personal computer that is connected to the Internet (not shown), and the video display 4 is a large screen televisions. Other video display technologies can also be utilized. The video display presents three video display regions, which include a streaming video display area 5, a server message display area 7, and a banner text display area 9. Note that these three display area are dynamic and do not necessarily appear simultaneously. And, note that additional display areas may be included to present further information from time to time. In certain embodiments, the banner text and server message portions may overlay the streaming video display portion, although it is preferred that the areas be discrete so as not to interfere with viewing of the streaming video. The video display 4 is positioned such that users (not shown) of the venue 2 can view the contents as a form of entertainment and information. In a typical embodiment, the audio portion of the video channel sent to the video display 4 is reproduced through a sound system (not shown), which is typically available in the form of a public address system at the venue 2.

The venue controller 6 receives the various video content through the Internet (not shown), but also has certain controls over the content that is displayed. In operation, the users make selections as to the video content they desire to watch as entertainment. This is accomplished using either a fixed user terminal 8 or portable wireless computing devices, or “smartphone” as input terminal devices, referred to as a client terminal. All of these terminals are Internet connected. In a typical application, users access a third party video server, such as YouTube.com, and searches for desirable content, such as a popular music video, and then select an item that is added to a queue to be reproduced on the video display 4. Any user in the venue 2 who has access to one of these terminals 8,10 can add content to this queue. In this manner, it is the users in the venue 2 that are enabled to determine what entertainment is presented over a period of time. The videos they might select are reproduced within the video display area 5 of the video display 2. The venue controller 6 is the device that receives the streaming video from the third party video server and reproduces it on the video display 4. In a typical implementation, the venue controller 6 outputs banner text that scrolls across the banner portion 9 of the video display 4. The scrolling text may be local advertisements or may be information that the venue operator desires be presented to the users at the venue 2. The server message portion 7 is also driven by the venue controller 6, but includes both textural and graphical content that is provided by a system level channel server (not shown). This content may be advertisements or information that is presented at the system level versus the local venue level. The flow of information to and from these devices, the communications protocols, and the external components of the system are further detailed in FIG. 2.

As discussed above, the systems and methods of the present disclosure enable users at a venue to select the entertainment they desire to view and listen to. This is somewhat analogous to the jukebox where users select the songs they want to listen to. The present invention contemplates financial compensation for enabling this service. The mode of operation is for the client terminals to search for and select desirable videos from third party streaming video servers, such as YouTube, Vimeo, VEVO, or others that are known or later become known. The selected videos are added to a queue by the client terminals, and are then played in sequence by the venue controller. The invention contemplates both a convention first-in, first-out (“FIFO”) queue, as well as a “play-next” priority queue. The play-next queue would be accessible by the users agreeing to a higher level of compensation for the service. Note that compensation can be both financial, as in paying a fee or expending tokens, or it can be an agreement to view an advertisement in advance of viewing the selected video. The venue operator, through the venue controller, and third party advertisers, input content for the text banner and server message portions of the display. All of the content is communicated to a channel server (not shown in FIG. 1), which servers the content, as a video channel, to individual venue controllers. The channel server can serve numerous channels that are hosted by numerous venue controllers. Thus, each of plural venues hosts channels, which are all served by the channel server. During operation, the banner text and server message portions are provided by the channel server, while the streaming video content is streamed to the venue controller directly from the respective third party video server. The issue of creative rights intellectual property rights for content presented in a venue is addressed in the same manner as for other uses of such rights, including jukeboxes, live performances and other performances, which is through a license grant from the respective intellectual property rights licensor, such as ASCAP, BMI, SESAC, and etc.

Reference is directed to FIG. 2, which is a system level functional block diagram according to an illustrative embodiment of the present invention. This figure presents the arrangement of system elements and communications protocols. The system is hosted on the Internet 16 and all of the communications follow the TCP/IP Internet transport protocols, which enables functionality throughout the Internet. The channel server 12 is the central node on the system, and is accessed through a console 17 interface for system configuration and management. The console 17 may also be direct connected or hosted through the Internet. The venue controller 6 operates through web browsers on the local venue 2 personal computer as a web page that is hosted by the channel server 12. Thus, the primary communications between the channel server 12 and the venue controller is HTML 18 coded web page hosting. In an illustrative embodiment, HTML5 is used because it functions well on a wide variety of fixed and mobile computing devices. A Push notification stream 20 is employed for the channel stream that is served to the venue controller 6. This is known to those skilled in the art as “Comet” programming. Comet is a web application model in which a long-held HTTP request allows a web server to push data to a browser, without the browser explicitly requesting it. Comet is an umbrella term, encompassing multiple techniques for achieving this interaction. All these methods rely on features included by default in browsers, such as JavaScript and HTML5, rather than on non-default plugins. The Comet approach differs from typical models of the web, in which a browser requests a complete web page at a time. Push notification is preferred for serving the video channel stream, rather than repeated requests for web page reloading from the venue controller, as will be appreciated by those skilled in the art.

The client terminals 8,10 in FIG. 2 include a fixed user terminal 8 and plural wireless computing devices with Internet access, most typically smartphone 10 and tablet devices. These devices 8,10 are also served a web page interface via HTML programming 18 from the channel server 12. The smartphones 10 are interconnected to the Internet trough a wireless network 14, as is understood by those skilled in the art. During operation, users (not shown) access the client terminals 8,10 at the venue 2 to search for and select video content, and to follow activity in the channel server and venue controller, including the user accounts, payments, system preferences, queues, searching, and video provider access. Note that while only a single channel, consisting of the venue controller 6 and display 4 is shown as being served by the channel server 12 in FIG. 2, the system contemplates an unlimited number of discrete channels. While the interface served to the users through client terminals 8,10 is accomplished by hosting a web page from the channel server 12 to a browser in these terminals, other embodiment contemplate the use of device specific application programs (APPS) written for the target devices. Note that much of the video content selected by users will be content already in existence on third party video servers, such as popular music and videos. The system also contemplates the use of videos recorded by the users themselves, such as activities engaged in presently at the local venue, which a user may desire to share by presentation on the video display 4. This is possible where the client terminal has native video recording capabilities. In this case, the user records a video, uploads the video to a video server, and then adds that video to the channel server queue for the local venue channel.

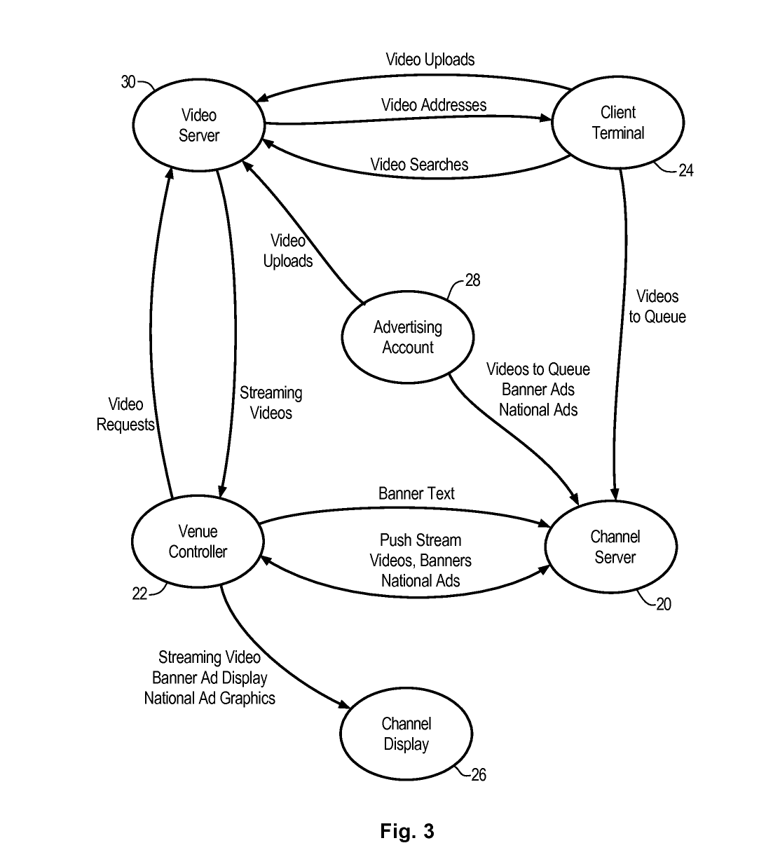

Reference is directed to FIG. 3, which is an information flow diagram according to an illustrative embodiment of the present invention. The channel server 20 serves discrete channel content to at least a first venue controller 22, however, the present invention contemplates a very large number of discrete channels located at a large number of discrete venues throughout the United States, and the world. The channel content is all communicated to the channel server 20, and is then served to the venue controllers 22 in the push stream. The channel content consists of banner text that is submitted from the venue controllers 22, or from third party advertisers who have advertising accounts 28 set up with permission to post advertising to the banner ads at predetermined local venues. This is a mechanism for monetizing the system, by selling advertising space on the banner text portion of the venue displays. The channel content also includes server messages, which are presented in the server message portion of the venue displays. This is a mechanism for national, or system level, advertising in that the channel server 20 serves this content to multiple venue controllers, and represents another technique for monetizing the service. The system messages are also referred to as “national ads”, and are submitted to the channel server 20 by advertising accounts 28, but can also be entered at system level terminals. National ads may include textural content, graphical content (.jpg, .gif, .png, and so forth), and video content. Of course, the channel content also includes the user's video files. In operation, what is provided to the channel server 20 is a uniform resource identifier of the video stream content at the third party video server's website 30. As the venue controller 22 is served a video channel stream from the channel server 22, the venue controller outputs the channel content to the channel display 26 for viewing by users at the venue. The streaming video is streamed from the third party video server 30 after the venue controller requests each video based on the uniform resource identifier delivered in the channel stream from the channel server 20.

The client terminal 24 in FIG. 3 accesses both the third party video servers 30 and the channel server 20. However, the access to the channel server 20 is always referenced to a discrete video channel identified with a particular venue controller 22 at a particular venue, and this relationship is established through the client terminal 24 user account and a presently selected local venue by the user. Client terminals 24 may roam from one local venue to another. The client terminal 24 accesses the video server 30 to conduct video searches, typically based on keyword searches or other offerings of the video server. In response to such a search, the video server 30 responds with a listing of search results that are presented on the client terminal display. A selection is made by the user, and then the uniform resource identifier of the selected video is sent from the client terminal 24 to the channel server 20, identified with the corresponding discrete channel identity. Note that in an illustrative embodiment, the video search and results are entered and presented using application programming interface (API) commands native to the video server 30. Also note the both the client terminal 24 and advertising account 28 are enabled to upload videos to the video server 30. In operation of delivering video channel content from the channel server 20 to the venue controllers, the channel server 20 pushes content to the venue controller 22, which displays the content on the channel display 26. In the case of the video uniform resource identifier, the venue controller 22 request the stream from the video server 30, and then displays the resultant video stream on the channel display 26 as it is received in real time. The banner text and national ads are presented with a start time and duration for display. For example, a banner txt may include the text string “Eat at Joe's Diner, 125 Main Street”, which is set to begin scrolling at 6:00 pm and run for fifteen minutes. Once this action has occurred, the venue controller 22 reports the completion of the task to the channel server 20. This enables the channel server to be certain that an ad has actually run. Similarly, once a National ad or video has been run through to completion, the venue controller 22 reports this action. In the case of videos, the report of completion prompts the next video in queue to be sent to the venue controller 22 from the channel server. The venue controller also has the ability to interrupt or terminate any video currently running, which is useful where a client terminal has queued something distasteful or otherwise not permitted. As a general principle, the venue controller has the ultimate control over what is displayed on the venue video display.

The client terminal 24 browser, or web application, accesses the channel server to establish an account on the system, where the system gathers certain personal and demographic information, which may include financial resources from settling charges that may be incurred from time to time. Once established, the client terminal can search for and access local channels at corresponding local venues, each of which has a discrete channel identity. In certain installations, the venue controller can also serve as the local client terminal, as this reduces the number of computing devices to a single unit. Since both the applications run as web pages on a browser window of the device, it is a simple matter to toggle between the two functions as needed, and to provide access security where required.

The channel server 20 and the venue controller 22 also have a range of communications tasks that are handled through the Internet interface. Among these is the ability for the venue controller to establish a new discrete channel account, which is a registration process more complex than that of a client terminal. The venue controller 22 may also settle financial transactions related to advertising revenue sharing. System level communications and set-up parameters can also be exchanged. The venue controller 22 can also establish a default video channel stream arrangement with the channel server 20, which includes default content when no higher level content is required to be displayed. For example, the venue controller 22 can select from a range of video files that establish a style for the venue, such as country and western music for a country bar and so forth. Also, the banner text defaults may include generic announcements about the venue when advertising is not currently being displayed.

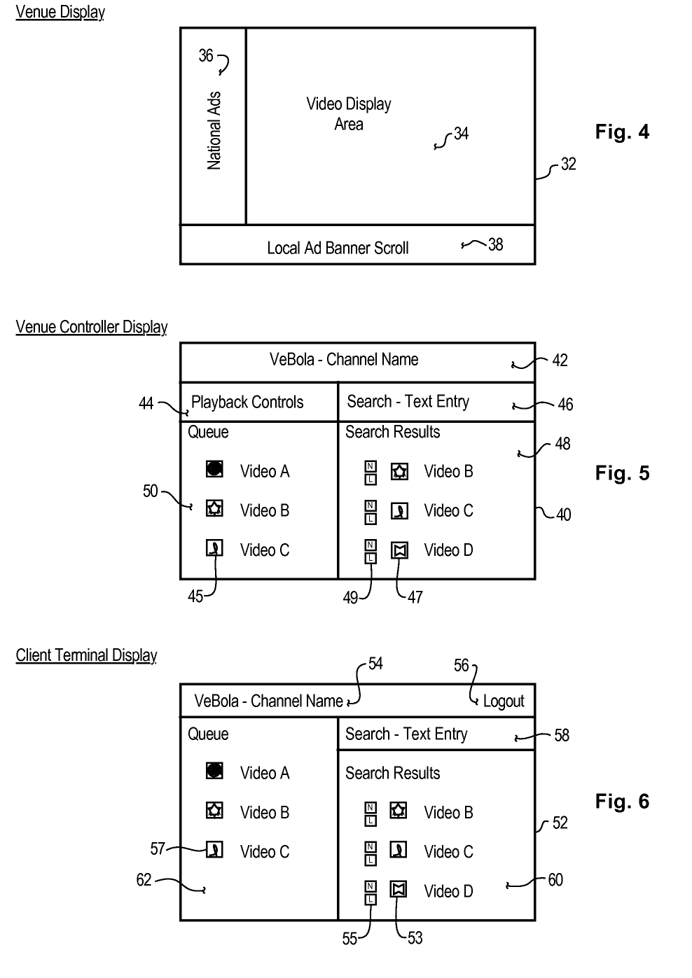

Reference is directed to FIG. 4, which is a drawing of a venue display screen 32 according to an illustrative embodiment of the present invention. In a typical embodiment, the venue display is a large flat-screen television receiver that has an HDMI port driven by a venue controller (not shown). As such, the resolution of the display will be 1920 by 1080 pixels. Of course, other display formats and resolution can be employed. The display resolution is divided into plural sections, and in the illustrative embodiment, there are three, the video display area 34, the local banner ad scroll area 38, and the national ad (also referred to as the server message area) display area. It is not necessary to make the display area allocations absolute. The video are 34 may be enlarged while the national ads area 36 is not in use, and the same is possible for the banner text area 38. In addition these areas can be moved to difference regions of the display 32 and changed from time to time. The ad areas 36, 28 may also overly the video being displayed.

Reference is directed to FIG. 5, which is a drawing of a venue controller screen 40 according to an illustrative embodiment of the present invention. The venue controller is the primary control point for a channel operator, and it is typically located at the local venue and is coupled to the video display that users view for entertainment and information. In an illustrative embodiment, the channel server service is branded VeBola™ and each local venue is assigned a VeBola™ channel name, which is displayed at the top of the venue controller screen in area 42, as illustrated in FIG. 5. The venue controller is enabled to conduct searches for video content, which can be added to a playback queue in a similar manner as client terminals. This is accomplished by entering search terms using the keyboard of the venue controller, where the entries are displayed in area 46 of the venue controller screen 40. The search is conducted using a API command call to the third party video server, which returns search results that are displayed in area 48 of the venue controller display screen 40. In this illustration, the results are labeled Video B, Video C, and Video D. Each video listed may also include a graphic representation 47 of the each video. For example, in the case of a music video, the graphic 47 may be a thumbnail image of the music album cover. Each video in the search results offers to actuator icons 49, which are labeled “N” and “L” in the illustrative embodiment. “L” is a selector for adding the particular video to the FIFO queue to be listed for playback in due course. The “N” actuator is selected to add the particular video to the Play-Next queue. Since this is the venue controller terminal, there is no monetary or compensation element to adding a video to the queue. They are added at the discretion of the venue operator.

As the videos are added to queue in FIG. 5, they are displayed in the queue listing area 50 of the venue controller display screen 40. They are presented in the playback order, with the top of the list being the next video queued for playback. Each video also presents a corresponding graphic 45. If a Play Next video is added, it is inserted into the queue at a higher position. In another embodiment, the venue controller may display two separate queues to show both the standard FIFO queue and the Play-Next queue. The venue controller also provides a set of playback controls, presented in area 44 of the venue controller display screen 40. Playback controls enable to the venue operator and channel owner control what is presented on the video display screen at the local venue. These controls may include pause, skip, replay, stop, rewind, and other controls as may be deemed useful.

Reference is directed to FIG. 6, which is a drawing of a generic client terminal display 52 according to an illustrative embodiment of the present invention. This display is appropriate for the fixed client terminal at a local venue. This display 52 includes a VeBola™ channel name field 54 identifying the currently selected channel name, and a logout option 56 to disable the terminal connection to the channel server, if desired. The client terminal is enabled to conduct searches for video content, which can be added to a playback queue. This is accomplished by entering search terms using the keyboard of the client terminal, where the entries are displayed in area 58 of the client terminal screen 52. The search is conducted using an API command call to the third party video server, which returns search results that are displayed in area 60 of the client terminal display screen 52. In this illustration, the results are labeled Video B, Video C, and Video D. Each video listed may also include a graphic representation 53 of the each video. For example, in the case of a music video, the graphic 53 may be a thumbnail image of the music album cover. Each video in the search results offers to actuator icons 55, which are labeled “N” and “L” in the illustrative embodiment. “L” is a selector for adding the particular video to the FIFO queue to be listed for playback in due course. The “N” actuator is selected to add the particular video to the Play-Next queue. The user may be presented a compensation option, such as paying a fee, expending some prepaid tokens, or agreeing to watch an advertisement just prior to playback of the selected video.

As the videos are added to queue in FIG. 6, they are displayed in the queue listing area 62 of the client terminal display screen 52. They are presented in the playback order, with the top of the list being the next video queued for playback. Each video also presents a corresponding graphic 57. If a Play-Next video is added, it is inserted into the queue at a higher position. In another embodiment, the client terminal may display two separate queues to show both the standard FIFO queue and the Play-Next queue.

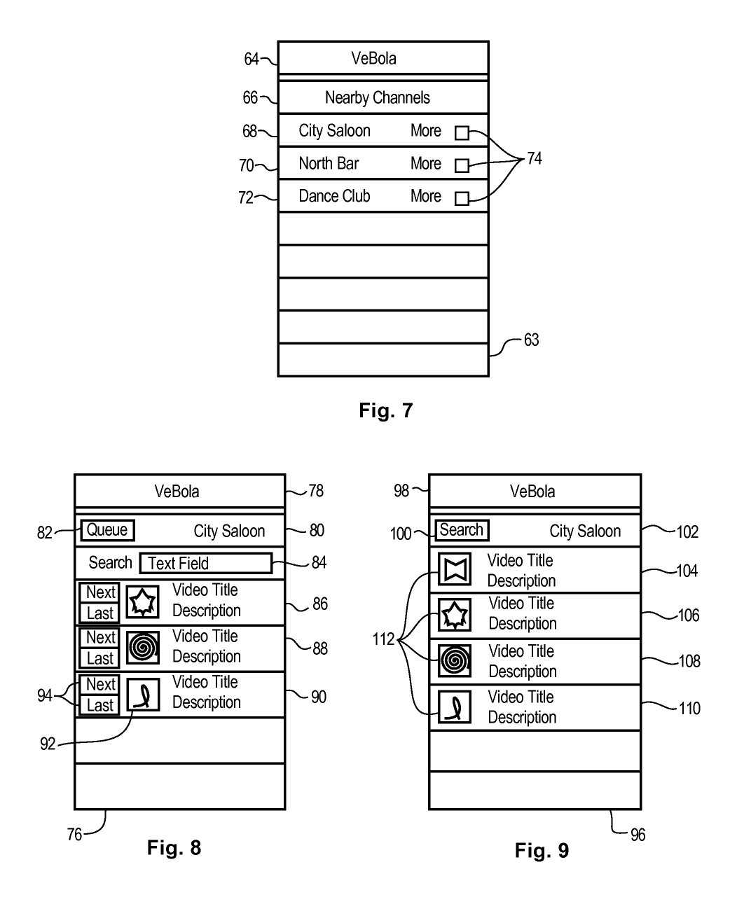

Reference is directed to FIG. 7, which is a drawing of a mobile client terminal display 63 according to an illustrative embodiment of the present invention. In the illustrative embodiment, the mobile client terminal display is presented as a web page in the native browser of the mobile device. In other embodiments, the user interface may be offered and a mobile device application program (APP) downloaded for use in the VeBola™ system. The top of the display 63 is a brand marker for the service, which is VeBola™ in this embodiment. A search function is presented and enables the mobile device to locate nearby local venues having VeBola™ venue controllers. This is accomplished using the GPS coordinates of the mobile device and comparing them to a database listing in the system channel server of local venue video channels in the immediate area. This provides two benefits. First, it enables the user to find VeBola™ enabled venues, and second, it limits the range at which a user can access and input videos to a local venue. A suitable range for this limit is about one-half mile. Other access security measures can also be implement to control access, as are known to those skilled in the art. A “Nearby Channels” actuator 66 is presented and returns a listing of the local channels, which includes “City Saloon” 68, “North Bar” 70, and “Dance Club” 72 in this example. Each item on the list offers a “More” actuator, which opens a new page showing further information about the venue, and may offer a map and directions.

Reference is directed to FIG. 8, which is a drawing of a mobile client terminal display 76 according to an illustrative embodiment of the present invention. This display presents the video search function for a mobile client terminal. The service brand, VeBola™ appears at the top 78, and the name of the currently enabled local venue channel name “City Saloon” appears in area 80. The mobile client terminal is enabled to conduct searches for video content, which can be added to a playback queue. This is accomplished by entering search terms through the mobile client terminal, where the entries are displayed in area 84 of the mobile client terminal screen 76. The search is conducted using an API command call to the third party video server, which returns search results that are displayed in areas 86, 88, and 90 of the mobile client terminal display screen 76. In this illustration, the results include both a video title and a description of the video, which are provided by the third party video server in response to the search. Each video listed may also include a graphic representation 92 of the each video. For example, in the case of a music video, the graphic 92 may be a thumbnail image of the music album cover. Each video in the search results offers to actuator icons 94, which are labeled “Next” and “Last” in the illustrative embodiment. “Last” is a selector for adding the particular video to the FIFO queue to be listed for playback in due course. The “Next” actuator is selected to add the particular video to the Play-Next queue. The user may be presented a compensation option, such as paying a fee, expending some prepaid tokens, or agreeing to watch an advertisement just prior to playback of the selected video. The search screen 76 of the mobile client terminal also presents a “Queue” actuator 82, which enables the user to view the current queue.

Reference is directed to FIG. 9, which is a drawing of a mobile client terminal display 96 according to an illustrative embodiment of the present invention. This screen follows the screen illustrated in FIG. 8. In FIG. 9, the queue screen is presented. The service brand, VeBola™ appears at the top 98, and the name of the currently enabled local venue channel name “City Saloon” appears in area 102. A “Search” actuator 100 is presented, which enables the user to return to the search screen to search for additional videos for addition to the queues. The queue display includes a listing of the upcoming videos for playback, which are labeled 104, 106, 108, and 110 in FIG. 9. each video may include a corresponding graphic 112, which are provided by the video server, as has been discussed hereinbefore. Alternatively, the mobile client terminal may offer separate displays for the FIFO queue and the Play-Next queue.

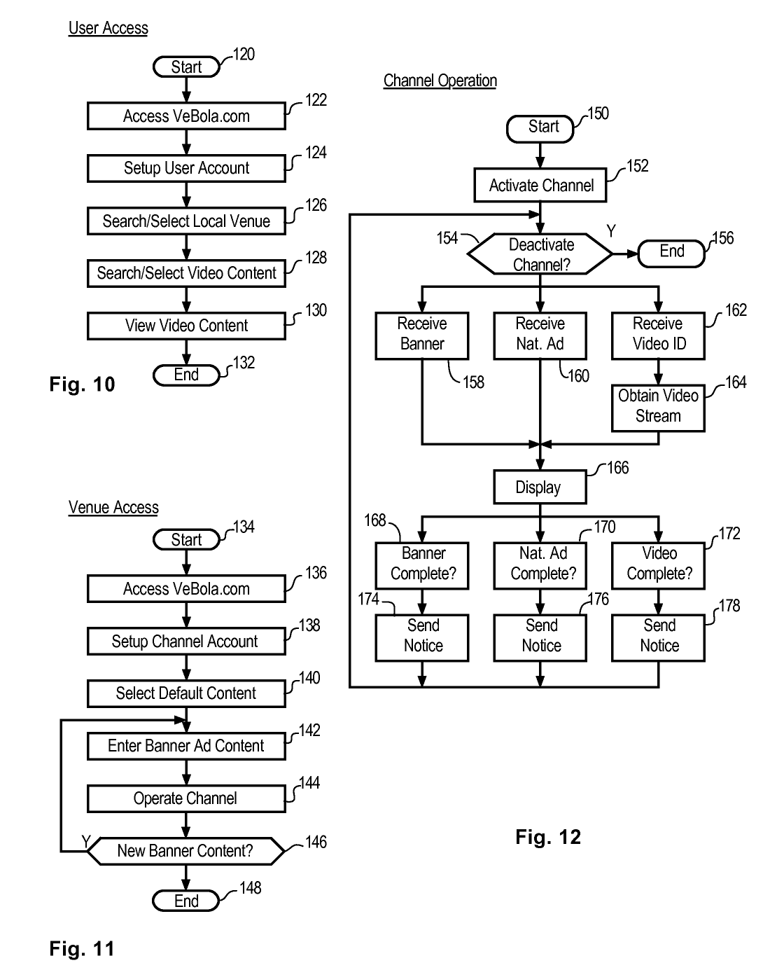

Reference is directed to FIG. 10, which is a user access sequence flow diagram according to an illustrative embodiment of the present invention. This presents a generic user access process of an illustrative embodiment. The process begins at step 120 and proceeds to step 122, where a user accesses the VeBola.com channel server using a client terminal. At step 124, the user sets up an account on the system by completing certain fields of user information. These fields may include name, address, telephone, e-mail, user preferences, credit, and demographic information. The user may also establish a line of credit or purchase tokens in advance for payment of services, such as inserting videos into a play-next queue. At step 126, the user searches for and selects a local venue for access and engagement. This search can be accomplished in a number of manners, including GPS positional information, maps, type of venues, types of entertainment, and so forth. Once a local venue has been selected, the user may conduct searches and select videos for insertion into playback queues at the selected local venues, as has been discussed hereinbefore. At step 130, the user views and enjoys the selection video content and the process ends at step 132.

Reference is directed to FIG. 11, which is a venue access flow diagram according to an illustrative embodiment of the present invention. This flow chart illustrates the processes that apply to a local venue is setting up a discrete video channel account and its operation. The process begins at step 134 and proceeds to step 138 where the venue owner accesses the channel server, VeBola.com in this embodiment, where a web site is hosted for access interface. At step 138 a channel account is established through the exchange of venue information, preferences, financial information, and access security parameters. At step 140, the venue owner selects a set of parameters for default channel operation, appearance, and default content. The venue owner may also establish advertising parameters at this point, or they may be added and updated at a later time. At step 142, the venue owner may enter initial banner text content, such as default scroll message. This information can be freely edited from time to time. At step 144, the channel begins and maintains operation through the server functions of the channel server and its recognition of the discrete channel and its channel identity, as well as advertisers, and client terminals. Video requests are accepted and queued, and nation advertising server messages are accepted and queued as well. At step 146, the local venue controller may submit new banner text content from time to time. The process ends at step 148.

Reference is directed to FIG. 12, which is a channel operation flow diagram according to an illustrative embodiment of the present invention. This is a typical venue controller operational process, which begins at step 150 and proceeds to step 152 where the channel owner activates the channel through the system channel server. The channel may be deactivated through the venue controller at step 154, which causes the process to end at step 156. If the channel continues operation at step 154, the venue controller awaits streaming content served from the channel server. The venue controller may receive banner text content at step 158, or it may receive national advertising (also referred to a server messages) at step 160, or it may receive a video uniform resource identifier for a streaming video at step 172. If a video stream identifier is received at step 162, then the venue controller contact the third party video server at step 164 to obtain the real time video stream. At step 166, any of the received banner, advertising, or video stream content is displayed on the venue video display at step 166. Display continues until the run time has completed, or the video is completed, which are tested at the corresponding step 168 for banner content, step 170 for national advertising content, and step 172 for completion of a video stream. On completion of any of these, the venue controller sends a notice of completion to the channel controller, correspondingly, at steps 174, 176, and 178, at which point the process returns to step 154 and steps 158, 160, and 162 to await the next items of content served from the channel controller.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

What is claimed is:

1. A system for selective delivery of video channel content to audiences of users at plural venues, the system comprising:
a channel server, coupled through the Internet, which receives video channel content consisting of uniform resource identifiers for streaming video server files, banner text, and server messages, organized by discrete video channel identities, and which serves portions of said video channel content, correspondingly, to plural discrete video channels;
at least a first venue controller coupled to receive first video channel content, identified by a first discrete video channel identity, from said channel server, and which sequentially displays banner text portions and server message portions of said first video channel content on a video display at a corresponding first venue, and which requests streaming video feeds from Internet video servers according to video server uniform resource identifier portions of said first video channel content, which are also sequentially displayed on said video display;
at least a first client terminal, coupled through the Internet, which provides an interface for a user search for video server uniform resource identifiers available on Internet video servers, and which communicates selected video server uniform resource identifiers, identified by said first discrete channel identity, to said channel server, and wherein
said channel server receives said selected video server uniform resource identifiers from said at least a first client terminal, and inserts said selected video server uniform resource identifiers into a queue for inclusion into said first video channel content which is served to said at least a first venue controller.

2. The system of claim 1, and wherein:
said banner text portions of said video channel content are advertisement messages served only to said at least a first venue controller according to said discrete channel identity.

3. The system of claim 1, and wherein:
server message portions of said video channel content are advertisement messages served to plural venue controllers according to plural discrete channel identities.

4. The system of claim 1, and wherein:
said channel server inserts a uniform resource identifier of a streaming video file into said queue of said at least a first venue controller that is an advertisement video, there by interspersing video advertisements into said served video channel content.

5. The system of claim 1, and wherein:
said channel server serves said video channel content immediately after said first venue controller sends acknowledgement that a prior item of video channel content display operation has been completed.

6. The system of claim 1, and wherein:
said channel server serves said video channel content, for each of said banner text, said server messages, and said uniform resource identifiers for streaming video server files, correspondingly, through a banner text queue, a system message queue, and a uniform resource identifiers for streaming video server files queue.

7. The system of claim 6, and wherein:
said banner text queue and said system message queue include a start time and duration time for display of each item therein.

8. The system of claim 1, and wherein:
said first client terminal provides a command with one of said selected video server uniform resource identifiers, and wherein
said channel server advances said one of said selected video server uniform resource identifiers to the top of said queue in response to receipt of said command.

9. The system of claim 1, and wherein:
said first venue controller allocates separate portions of said video display for reproduction of said banner text portion, said server message portions, and said streaming video feeds.

10. The system of claim 1, and wherein:
said server messages comprise graphical files that are uploaded to said channel server by a third party advertiser.

11. A method for selectively delivering video channel content through the Internet to audiences of users at plural venues using a channel server, at least a first venue controller coupled to a video display, and at least a first client terminal, the method, comprising the steps of:
receiving video channel content, by the channel server, consisting of uniform resource identifiers for streaming video server files, banner text, and server messages, organized by discrete video channel identities, and serving portions of the video channel content, correspondingly, to plural discrete video channels;
receiving first video channel content from the channel server, by the first venue controller, identified by a first discrete video channel identity, and which sequentially displaying banner text portions and server message portions of the first video channel content on the video display at a corresponding first venue, and requesting streaming video feeds from Internet video servers, by the first venue controller, according to video server uniform resource identifier portions of the first video channel content, and, sequentially displaying the streaming video feeds on the video display;
searching for video server uniform resource identifiers available on Internet video servers by the first client terminal, and communicating selected video server uniform resource identifiers, identified by the first discrete channel identity, to the channel server, and
receiving, by the channel server, said selected video server uniform resource identifiers from the first client terminal, and inserting said selected video server uniform resource identifiers into a queue for inclusion into the first video channel content, and serving it to said a first venue controller.

12. The method of claim 11, further comprising the steps of:
inserting advertising messages into the banner text portions of the video channel content, and serving them only to the first venue controller according to the discrete channel identity.

13. The method of claim 11, further comprising the steps of:
inserting advertisement content into the server message portions of the video channel content, and serving them to plural venue controllers according to plural discrete channel identities.

14. The method of claim 11, further comprising the steps of:
inserting, by the channel server a uniform resource identifier of a streaming video file into the queue of the first venue controller that is an advertisement video, thereby interspersing video advertisements into the served video channel content.

15. The method of claim 11, further comprising the steps of:
displaying and item of video channel content by the first venue controller;
sending an acknowledgement, by the first venue controller, that the item of video channel content displaying operation is complete, and
serving another item of video channel content, by the channel server, upon receipt of said acknowledgement.

16. The method of claim 11, further comprising the steps of:
serving said video channel content, by the channel controller, for each of the banner text, the server messages, and the uniform resource identifiers for streaming video server files, correspondingly, through a banner text queue, a system message queue, and a uniform resource identifiers for streaming video server files queue.

17. The method of claim 16, and wherein:
the banner text queue and the system message queue include a start time and duration time for displaying of each item therein.

18. The method of claim 11, further comprising the steps of:
sending a command, by the first client terminal, together with one of the selected video server uniform resource identifiers, and wherein
said channel server advancing said one of said selected video server uniform resource identifiers, by the channel server, to the top of said the in response to receipt of the command.

19. The method of claim 11, further comprising the steps of:
allocating separate portions of the video display, by the first venue controller, and reproducing the banner text portion, the server message portions, and the streaming video feeds in said separate portions of the video display.

20. The system of claim 1, further comprising the steps of:
uploading graphical files within the server messages to said channel server by a third party advertiser.
